(19) United States
(12) Patent Application Publication
(10) Pub. No.: US 2023/0250912 A1
(43) Pub. Date: Aug. 10, 2023

(54) REHABILITATION PACKER FOR PIPE AND SEWER REHABILITATION

(71) Applicant: Härke GmbH & Co. KG, Remscheid (DE)

(72) Inventors: Stephan Kloeber, Hückeswagen (DE); Joachim Berger, Wermelskirchen (DE)

(21) Appl. No.: 18/098,735

(22) Filed: Jan. 19, 2023

(30) Foreign Application Priority Data
Jan. 28, 2022 (DE) 20 2022 100 497.8

(51) Int. Cl. F16L 55/165

(52) U.S. Cl. CPC F16L 55/1654

(57) ABSTRACT

A rehabilitation packer for pipe and sewer rehabilitation that includes a balloon-like expandable and tubular sleeve that can be pressurized with a pressurized medium. The sleeve is respectively sealed at both its ends with an end plug and has a peripheral lining insert at both its ends which limits an expansion of the sleeve. The respective lining insert has material recesses running in the axial direction and mutually peripherally spaced from each other starting from its peripherally sealed initial area which is adjacent to the respective end plug and insert extensions are configured between the material recesses. A sleeve for use in such a rehabilitation packer is also described.

### CROSS REFERENCE TO RELATED APPLICATIONS

This application claims the benefit of priority under 35 U.S.C. § 119 to German Utility Model 20 2022 100 497.8, filed Jan. 28, 2022, the contents of which is incorporated herein by reference in its entirety.

### FIELD

The invention relates to a rehabilitation packer for pipe and sewer rehabilitation.

### BACKGROUND

The statements in this section merely provide background information related to the present disclosure and several definitions for terms used in the present disclosure and may not constitute prior art.

A rehabilitation packer is disclosed in DE 10 2008 021 956 B4. Such rehabilitation packers are used for the rehabilitation of tubular conduits or sewers. These rehabilitation packers can be pulled or pushed into the tubular conduits to be rehabilitated. For the purpose of filling them with pressurized medium, they are provided at one end with a connection for a suitable pressurized medium such as, for example, air or water. After such a rehabilitation packer has been wrapped over its periphery, for example, with a laminate soaked in adhesive, it is positioned at the location to be rehabilitated in the interior of the tubular conduit and filled with the pressurized medium. The rehabilitation packer hereby expands like a balloon, so that the rehabilitation laminate can be pressed onto the damaged area in the interior of the tubular conduit and attaches to it. After the rehabilitation laminate has hardened, the pressurized medium is drained and the rehabilitation packer can be removed, for example, pulled out.

However, in these rehabilitation packers a weakening of the sleeve material occurs at the transition from the lining insert to the exposed sleeve in generic rehabilitation packers as a result of the repeated filling with pressurized medium and the balloon-like expansion of the sleeve that occurs as a result, which causes the service life of the sleeve to be significantly limited.

It is therefore an objective of the present disclosure to prevent the aforementioned disadvantage and thus increase the service life of a generic rehabilitation packer.

### SUMMARY

The aforementioned objective of the present disclosure is attained by rehabilitation packer that comprises a balloon-like expandable and tubular sleeve that can be pressurized with a pressurized medium, which is respectively sealed at both its ends with an end plug. The sleeve has a peripheral lining insert at both its ends which limits the expansion of the sleeve. The respective lining insert has material recesses running in the axial direction and mutually peripherally spaced from each other starting from a peripherally sealed initial area which is adjacent to the respective end plug and insert extensions are configured between the material recesses.

According to one aspect of the present disclosure, a fluid transition from the predominantly rigid, peripherally sealed initial section of the lining insert to the balloon-like expandable elastic sleeve section is created as a result of the formation of peripherally spaced, axially running recesses and the material extensions formed between them through the breaking up of the predominantly rigid edge region of the lining insert, so that no abrupt transition between the lining insert and the expandable sleeve is created. An excessive strain of the sleeve material in the transition area between the lining insert and the freely expandable sleeve section is prevented in this way.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a perspective view of a rehabilitation packer according to the conventional art; and

FIG. 2 shows a perspective view of a rehabilitation packer according to the present disclosure.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the rehabilitation packer comprises a balloon-like expandable and tubular sleeve that can be pressurized with a pressurized medium, which is respectively sealed at both its ends with an end plug. The sleeve has a peripheral lining insert at both its ends which limits the expansion of the sleeve. The respective lining insert has material recesses running in the axial direction and mutually peripherally spaced from each other starting from a peripherally sealed initial area which is adjacent to the respective end plug and insert extensions are configured between the material recesses.

An optimal adaptation to the respective diameter and length of the sleeve as well as the required internal pressure for expanding the sleeve, which is dependent from the respective sleeve material, can be achieved by means of the embodiments of the material recesses and the insert extensions disclosed herein. An optimization regarding whether or not a rehabilitation packer for straight or curved conduits is needed is also possible. The present disclosure likewise relates to a sleeve for use in the generic rehabilitation packer according to the features described above and further defined herein.

The rehabilitation packer of the present disclosure is described in more detail with the aid of the exemplary embodiments represented in the drawings provided herein. Identical parts are always identified with the same reference numerals in the various figures of the drawings.

Concerning the following description, it is claimed that the present disclosure is not limited to the exemplary embodiments and is consequently not limited to all or several of the features of the described feature combinations but rather each individual partial feature of the/each exemplary embodiment is of importance to the objective of the present disclosure also separately from all other partial features described in connection therewith per se and also in combination with any desired features of another exemplary embodiment.

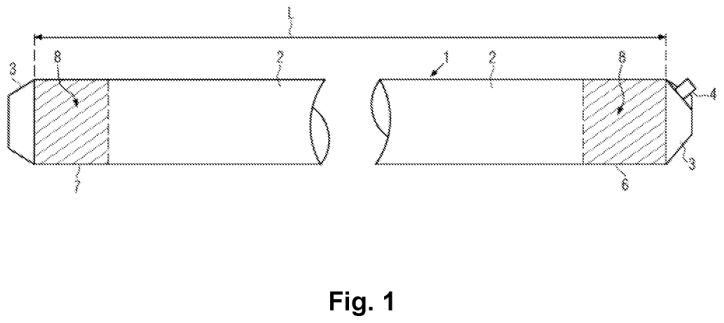

In FIG. 1 is shown a conventional rehabilitation packer 1. This conventional rehabilitation packer 1 comprises a sleeve 2 which can be pressurized or filled with a pressurized medium. The sleeve 2 is configured in a tubular shape and has preferably a fundamentally circular cross section in its unfilled state. This sleeve 2 is sealed in a fluid-tight manner via end plugs 3 at both its ends. The sleeve 2 can be filled with the pressurized medium and the pressurized medium can be emptied from the sleeve 2 in that the sleeve is filled with a pressurized medium, for example, air or water, via a filling connection 4 in one of the end plugs 3. The sleeve 2 furthermore has respectively one peripherally running lining insert 8 at both its end areas 6, 7. This lining insert 8 has the effect that the expansion of the sleeve 2 during filling with the pressurized medium is restricted, in particular that it is essentially prevented, so that the sleeve 2 expands essentially radially in the area between the two lining inserts 8, and namely in the shape of a balloon.

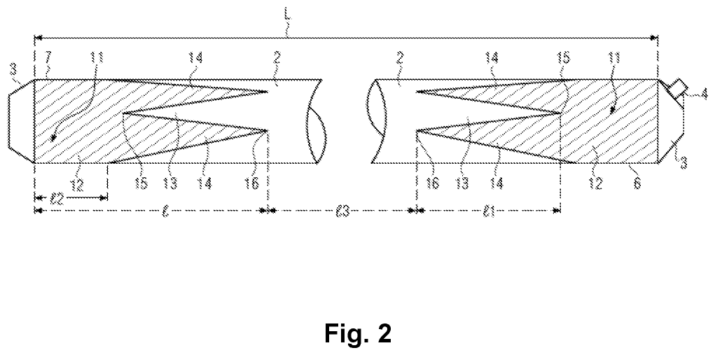

In FIG. 2 is shown a rehabilitation packer 10 formed according to the teachings of the present disclosure. The rehabilitation packer 10 of the present disclosure likewise comprises all of the components described in FIG. 1. In contrast to FIG. 1 and the correspondingly described lining insert 8, however, the lining insert 8 shown in FIG. 2 has been substantially modified. The lining inserts 11 shown peripherally arranged respectively at both end areas 6, 7 in FIG. 2 have a peripherally sealed, especially rigid initial area 12 in the connection area of the end plugs 3. From this initial area 12 extend peripherally mutually spaced material recesses 13 in the lining insert 11, which run in the axial direction, so that the lining insert 11 is not peripherally sealed in this area. Insert extensions 14 are configured in this way between the material recesses 13. The material recesses 13 can be configured identically or differently, whereby advantageously equally large and mutually identically spaced material recesses 13 are provided. The configuration of the material recesses 13 is also contingent on the size, shape, and peripheral arrangement of the insert extensions 14.

In the represented exemplary embodiment, the material recesses 13 are triangular in shape and are preferably shaped as an acute triangle, wherein the triangle points with its tip 15 in the direction of the respectively corresponding end plug 3. The corresponding insert extensions 13 are likewise configured in a triangular shape, so that they have the shape of spikes. The contained acute angle in the area of the tip 15 of the material recesses 13 advantageously has an acute angle of 3° to 45°, preferably of 5° to 25°. The contained acute angle has a size especially within the range of 15° to 25° with a length L of the sleeve 2 of 1000 mm, and a size within the range of 5° to 15° with a length L of 2000 mm in the area of the tip 15 of the material extensions 13. An acute angle of 5° bis 25° is advantageous with a length L of the sleeve 2 within the range of 1000 mm to 2000 mm.

The especially rigid initial area 12 has preferably a length l2 within the range of 250 mm to 300 mm. A central area that is free of lining insert between the two lining inserts 11 has a length l3 of preferably 300 mm with any sleeve length. From this results a length l1 of the insert extensions 14 or the material recesses 13 within the range of 100 mm to 50 mm with a length L of the sleeve 2 of about 1000 mm. A length l1 of the insert extensions 14 or the material recesses 13 within the range of 600 mm to 550 mm results with a length L of the sleeve of preferably 2000 mm.

The insert extensions 14 have a tip 16, which points toward the opposite lining insert 11.

According to another aspect of the present disclosure, the rehabilitation packer may also comprise material recesses 13 and insert extensions 14 that are rounded at their tips 15, 16. It is also within the scope of the invention if the material recesses 13 are configured with an arched concave shape as well as if the insert extensions 14 lying between them are configured with an arched convex shape. The number, size, and shape of the material recesses 13 as well as the insert extensions 14 are respectively dependent from the length, the diameter, and/or the material of the sleeve 2. With a length L of the sleeve 2 of approx. 1000 mm, the length l of the lining insert 11 which comprises the peripherally sealed initial area 12 and the subsequent insert extensions 14, is preferably 350 mm. All types of lining used in the production of rubber, especially tire cord fabric, nylon, or Kevlar can be used as material for the lining insert 11. The sleeve 2 is advantageously made from a rubber-like elastic material, especially a polymer such as natural rubber, styrene-butadiene rubber, and ethylene-propylene terpolymerizate, or other suitable polymers. The elasticity and the bendability of the sleeve 2 are preferably such that a bending flexibility of the sleeve 2 is provided, so that a use as a curved rehabilitation packers for pipe and sewer repair is made possible.

The invention is not limited to the exemplary embodiments shown and described herein but also comprises all of the embodiments operating in the sense of the invention. It is expressly emphasized that the exemplary embodiments are not limited to all the features in combination, but that rather each individual partial feature per se is of inventive importance also separately from all other partial features. The invention is furthermore so far also not limited to the feature combination defined herein but can also be defined by any other desired combination of specific features of all overall disclosed individual features. This means that basically practically each individual feature described herein can be omitted or replaced by at least one other individual feature disclosed at another point of the application.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A rehabilitation packer for pipe and sewer rehabilitation, the rehabilitation packer comprising a balloon-like expandable and tubular sleeve that can be pressurized with a pressurized medium, which is respectively sealed at both its ends with an end plug, and wherein the sleeve has a peripheral lining insert at both its ends which limits the expansion of the sleeve,
wherein the respective lining insert has material recesses running in the axial direction and mutually peripherally spaced from each other starting from a peripherally sealed initial area which is adjacent to the respective end plug and insert extensions are configured between the material recesses.

2. The rehabilitation packer according to claim 1, wherein the material recesses have a triangular shape, wherein the tip of the material recesses points toward the peripheral initial area.

3. The rehabilitation packer according to claim 2, wherein the shape of the material recesses is an acute angle triangle, wherein the contained acute angle at the tip is within a range of 3° to 45°.

4. The rehabilitation packer according to claim 2, wherein the insert extensions are configured with a triangular shape in adaptation to the material recesses, wherein the tip of the material extensions points toward the respectively opposite end of the sleeve.

5. The rehabilitation packer according to claim 1, wherein the material recesses are provided with an arched concave shape and the insert extensions are provided with an arched convex shape.

6. The rehabilitation packer according to claim 1, wherein the number of material recesses or insert extensions is dependent from the length (L) of the sleeve and from its diameter.

7. The rehabilitation packer according to claim 1, wherein a central area of the sleeve having a length (l3) of 300 mm, which is free from a lining insert, is configured between the lining inserts.

8. The rehabilitation packer according to claim 1, wherein the sleeve has an initial area having a length (l2) within the range of 250 mm to 300 mm.

9. The rehabilitation packer according to claim 8, wherein a length (l1) of the insert extensions or the material recesses is within the range of 100 mm to 50 mm and the sleeve has a length (L) of 1000 mm.

10. The rehabilitation packer according to claim 1, wherein the rehabilitation packer has a curved configuration, wherein the elasticity and bendability of the sleeve is such that a bending flexibility is given.

11. The rehabilitation packer according to claim 1, wherein the lining inserts comprise a lining based on tire cord fabric, nylon, or Kevlar, and the sleeve is comprised of a polymer material.

12. A sleeve for use with a rehabilitation packer, wherein the sleeve comprises the features according to claim 1.

13. The rehabilitation packer according to claim 3, wherein the contained acute angle at the tip is within a range of 5° to 25°.

14. The rehabilitation packer according to claim 4, wherein the shape of the material extensions is an acute angle triangle, wherein the contained acute angle at the tip is within a range of 3° to 45°.

15. The rehabilitation packer according to claim 14, wherein the contained acute angle at the tip is within a range of 5° to 25°.

16. The rehabilitation packer according to claim 8, wherein a length (l1) of the insert extensions or the material recesses is within the range of 600 mm to 550 mm and the sleeve has a length (L) of 2000 mm.

17. The rehabilitation packer according to claim 11, wherein the polymer material of the sleeve is natural rubber, styrene-butadiene rubber, ethylene-propylene terpolymerizate, or a mixture thereof.
